(19) United States
(12) Patent Application Publication
(10) Pub. No.: US 2025/0272759 A1
(43) Pub. Date: Aug. 28, 2025

(54) PRECOMPILED DATA PROCESSING MODEL

(71) Applicant: Sure, Inc., Dallas, TX (US)

(72) Inventors: Wayne Slavin, Santa Monica, CA (US); Christopher Cummings, Nashville, TN (US); Yarden Sachs, Los Angeles, CA (US)

(21) Appl. No.: 19/065,263

(22) Filed: Feb. 27, 2025

Related U.S. Application Data
(60) Provisional application No. 63/558,459, filed on Feb. 27, 2024.

(51) Int. Cl. G06Q 40/08; G06F 8/41; G06Q 30/0201

(52) U.S. Cl. CPC G06Q 40/08; G06F 8/41; G06Q 30/0206

(57) ABSTRACT

A data processing model builder precompiles a data processing model using a dependency tree and parameters provided by a provider of a product or service. New parameters can be provided in an intuitive way, without the need to understand computer program code, and a new data processing model can be compiled quickly and efficiently. The precompiled data processing model can then be deployed to provide personalized parameters for the product or service to end users almost instantaneously on request.

### CROSS-REFERENCE TO RELATED APPLICATIONS

This Application claims the benefit of U.S. Provisional Patent Application No. 63/558,459, filed Feb. 27, 2024, which is incorporated by reference.

### BACKGROUND

### 1. Technical Field

The subject matter described relates generally to data processing models and, in particular, to precompiling a data processing model to provide rapid results at runtime.

### 2. Background Information

There are many scenarios in which calculating one or more output values given a set of input parameters is valuable. For simple calculations, a brute force computation approach can be adopted where one or more computers simply make calculations to determine the output values. However, for more complicated calculations (e.g., where there are interdependencies between input parameters and calculations rely on external values that may be dynamically changing), even top of the line computing systems may not be able to calculate the desired output values in a reasonable time frame during which the output values are useful. For example, if a calculation depends in part on an external variable that changes every minute or every hour, etc., and the calculations take longer to perform than the update rate of the external variable, the calculations are essentially useless.

One example of this is a Rate Order Calculator (ROC) that calculates a rate for a product using a complex set of interrelated equations. The values of variables in the equations can depend on other equations, meaning that while a ROC is ultimately deterministic, calculation of the rate involves complex logic. Consequently, conventional ROCs are bespoke to a specific product and scenario, with development being a time and resource intensive process. Individuals from both product management and engineering groups typically work together to create software (a ROC) that can calculate the rate for a specific product. Adapting the resulting ROC to a different use case (or even just a change in some of the underlying parameters used) also requires significant time and effort and thus does not scale well to a large number of products or products with frequent parameter changes.

### SUMMARY

The above and other problems may be addressed by a data processing model builder that precompiles data processing models (e.g., ROCs) using a graph structure. An operator can provide new parameters in an intuitive way, without the need to understand computer program code, and a new data processing model can be compiled quickly and efficiently. The precompiled data processing model can then be deployed to provide one or more desired parameter values to end users almost instantaneously on request (e.g., within one second of requesting a value).

In one embodiment, a method of calculating a personalized parameter value for a product or service using a precompiled data processing model includes receiving a request for the personalized parameter value. The request includes information regarding the requestor. The method further includes applying the requestor information as input to the precompiled data processing model. The data processing model was precompiled by a process including receiving parameters, building a graph representing dependencies between the parameters and attributes of the data processing model, and compiling the data processing model using the parameters and the graph. The method also includes receiving the personalized parameter as output from the precompiled data processing model and providing the personalized parameter for display to the requestor.

### BRIEF DESCRIPTION OF THE DRAWINGS

FIG. 1 is a block diagram of a networked computing environment in which a data processing model builder may be deployed, according to one embodiment.

FIG. 2 is a block diagram of the server shown in FIG. 1, according to one embodiment.

FIG. 3 is a flowchart of a method for precompiling a data processing model, according to one embodiment.

FIG. 4 is a flowchart of a method for using a precompiled data processing model to calculate a rate, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

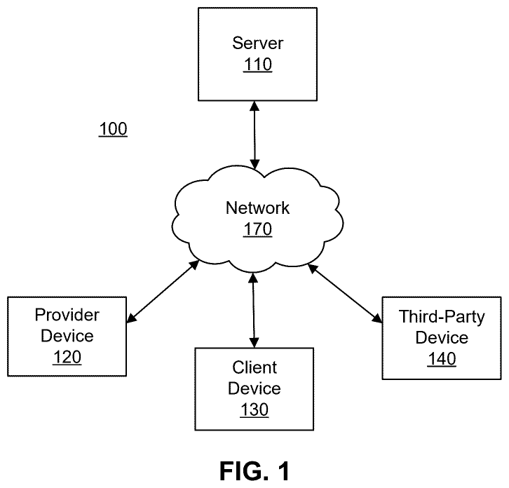

FIG. 1 illustrates one embodiment of a networked computing environment 100 in which a data processing model builder may be deployed. In the embodiment shown, the networked computing environment 100 includes a server 110, a provider device 120, a client device 130, and a third-party device 140. Although only one of each component is shown, the networked computing environment 100 may include any number of each type of component. In other embodiments, the networked computing environment 100 includes different or additional elements. In addition, the functions may be distributed among the elements in a different manner than described. For example, the functionality of two or more components may be combined and provided by a single component.

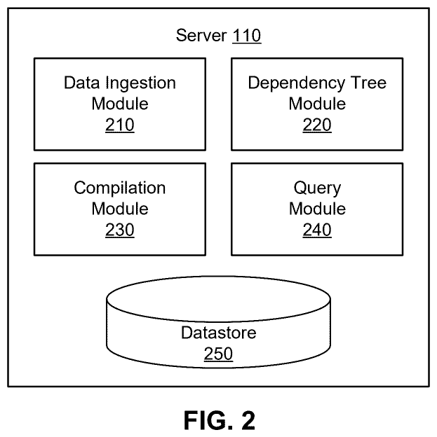

The server 110 is one or more computing devices that are configured collectively to build a data processing model and use the data processing model to calculate personalized parameters for clients (e.g., personalized rates for a client to obtain a product or service from a provider). In one embodiment, the server 110 builds a data processing model from files (e.g.,. csv files) including model parameters by creating a dependency tree indicating how attributes of the data processing model are influenced by the parameters and compiling the data processing using the parameters and the dependency tree. Compiling the data processing model involves calculating arithmetic formulas for determining the output of the data processing model (i.e., the personalized parameter(s), such as a rate) for every possible set of inputs. Thus, the server 110 can then calculate personalized parameters in response to requests with a single set of lookups of attribute values with the precompiled data processing model rather than having to perform multiple lookups to evaluate dependencies between attributes. Alternatively, the server 110 may go a step further and precompute the output value (i.e., rate) for every possible input. Various embodiments of the server 110 are described in greater detail below, with reference to FIG. 2.

A provider device 120 is a computing device with which providers of products and services may interact with the server 110 to obtain personalized parameters for clients who receive those products and services. In one embodiment, the providers are insurance companies that receive amounts of insurance premiums (rates) that should be paid by clients from the server 110 based on information about the clients. A provider device 120 may provide at least two distinct functionalities: building a new data processing model and obtaining one or more personalized parameters (e.g., a rate) using a precompiled data processing model. Each functionality may be provided via a user interface. The user interfaces may be combined into a single application, webportal, or other interface, or each may be provided separately (e.g., an actuary may use a first interface to provide parameters with which to build a new data processing model while a salesperson may use a second user interface to obtain a quote for a product or service to provide to a client using a second interface).

To build a new data processing model, an operator of the provider device 120 provides parameters for the data processing model to the server 110 via the user interface. The parameters may be provided in one or more files (e.g., .csv files). In one embodiment, the parameters may define factors such as a base rate, parameters for provision of the product or service (e.g., deductible amount, maximum claim amount, or other coverage choices, etc.), a geographic modifier (e.g., by state, county, or city, etc.), demographic modifiers (e.g., by age, gender, etc.), applicable discounts (e.g., homeowner bundle, good student discount, etc.), and a wide range of other factors. Essentially any factor that the operator chooses to have impact the final rate may be provided. At least some of the factors are defined using formulas that depend on other factors.

To obtain one or more personalized parameters for a client using a precompiled data processing model, an operator of the provider device 120 provides information about the client. The user interface may guide the operator through providing the relevant information, which corresponds to the factors used to compile the data processing model. For example, if the data processing model considers state of residence and age in determining the personalized parameter(s), the information about the client obtained via the user interface can include the client's state of residence and current age (or birthday, from which age can be calculated), etc. The server 110 provides the client information to the precompiled data processing model, which deterministically calculates the corresponding personalized parameter(s) and provides it/them to the provider device 120. Alternatively, personalized parameters can be provided directly to clients, as described below with reference to the client device 130.

A client device 130 is a computing device with which a client can interact with the server 110 and/or a provider device 120. In one embodiment, a client uses a user interface (e.g., an app or webform) to request one or more personalized parameters for a product or service (e.g., a quote for the premium to obtain an insurance product). The user interface guides the client to provide relevant client information. In some cases (e.g., if the client is a returning client), some or all of the client information may be retrieved from a database (e.g., at the server 110) rather than the client having to provide it each time. For example, the client may have an account and provide credentials (e.g., a username and password) and then the relevant client information (e.g., state of residence, demographic information, special offers the client qualifies for, etc.) may be retrieved from the server 110 and presented to the client for verification. Regardless of how the client information is obtained, it is provided as input to a precompiled data processing model that outputs the personalized parameter(s) for presentation to the client at the client device 130. The user interface may also include controls enabling the client to accept the rate and obtain the product or service (e.g., by causing the client to be bound to an insurance contract by the server 110).

A third-party device 140 is a computing device that provides information used by a data processing model to calculate personalized parameters. Some of the parameters used in compiling a data processing model or calculating a personalized parameter using a precompiled data processing model may be obtained from a third-party device 140. For example, the modifier for a state in which a client is resident may be based on third-party data regarding recent events (e.g., transactions or claims) in that state, predicted future events in that state, credit scores, or motor accident histories, etc. When such third-party data is needed, the server 110 can query the third-party device 140 for the relevant data. Alternatively, the third-party device 140 may periodically or on demand provide potentially relevant data (e.g., in a data feed to which the server 110 subscribes) and the server 110 stores a copy of the most recently provided data (and potentially a certain amount of historical data) in a database.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes a data ingestion module 210, a dependency tree module 220, a compilation module 230, a query module 240, and a datastore 250. In other embodiments, the server 110 includes different or additional elements. In addition, the functions may be distributed among the elements in a different manner than described.

The data ingestion module 210 receives data for building a data processing model (e.g., from a provider device 120) and parses it to extract relevant information. In one embodiment, the values for parameters are provided in .csv files with data in columns. For example, the modifier for different states may be provided by a two-column table with state identifiers in one column and the corresponding modifier in the other column. Thus, a provider can add new states, territories, or other type of jurisdiction by simply adding another row to the table and recompiling the data processing model. It should be appreciated that new options for any other parameter may be added in a similar way.

As described previously, some attributes of a data processing model are not single values set by the provider. Rather, attributes may depend on other attributes according to a formula. The dependency tree module 220 identifies these dependencies between attributes using a dependency tree. The dependent attributes and corresponding formulas may be set by the provider. Additionally or alternatively, dependent attributes and the corresponding formulas may be set by other entities (e.g., according to industry norms or regulations, etc.). In sum, the dependency tree module 220 determines dependencies between attributes and creates a dependency tree that maps out a strategy for calculating each attribute in view of the dependencies.

In one embodiment, the dependency tree module 220 starts with a product definition, which is a data object representing the features of the product or service to be provided, such as an amount of insurance coverage, what is covered, exceptions and deductibles, etc. The product definition can have a tree structure with metadata attached to the various nodes.

The product definition is fed into a rating system and converted into a graph (referred to as a “Ref Graph”). The Ref Graph includes nodes with information derived or copied from the product definition. The dependency tree module 220 obtains rating tables (e.g., via an upload from a provider device 120) that includes information about factor that impact the one or more personalized parameters the ultimate data processing model is intended to calculate. The rating system analyzes these tables and produces mapping expressions that calculate values from existing nodes. Nodes are then added into the Ref Graph that tie together one or more other nodes in the graph together and produce an output node that takes a value or values according to the corresponding reference expression. Mapping expressions can be recursive. In some embodiment, mapping expressions can be manually tweaked by an operator via a GUI (e.g., in a user interface displayed at a provider device 120).

The dependency tree module 220 also adds nodes for arithmetic expressions referred to as “calculations.” Each calculation may have a name (e.g., “Final Premium”, or some intermediary calculation). Each element of a calculation is a reference to other nodes in the Ref Graph, including other calculations. For example, if r1 and r2 are two references in the Ref Graph, then calculation cl could be expressed as r1+r2 and the effect of referencing cl within another calculation c2 could be expressed as c1*r3, which can be unrolled to (r1+r2)*r3, and so on. Each node in the Ref Graph may be referenced many times throughout the rest of the graph. In some embodiments, further nodes that can be added into the Ref Graph, such as “Constants,” which are static values inserted into the graph that are used in calculations, or “Aggregate Functions,” which can be referenced within an “Aggregate Calculation” to apply a named function to one or more nodes within the graph (e.g. mean (c1, c2, c3) to calculate the mean value of the results of three calculations).

In some embodiments, some or all of the nodes of the Ref Graph are annotated with a scope label that can limit what other nodes it can reference. This may enable variadic calculations by automatically limiting calculations to a subset of nodes in the Ref Graph (e.g. some calculation based on the value of each vehicle on an auto policy).

The compilation module 230 compiles a data processing model from the Ref Graph by using the formulas to calculate dependent attributes. In one embodiment, the compilation module 230 calculates sufficient dependent attributes that the resulting data processing model contains only arithmetic formulas where no required value to be calculated (i.e., values not calculated during compilation) is dependent on any other value that has not been calculated. Put another way, the compiled data processing model is a linear formula for calculating rates with no dependencies between variables. In some embodiments, whenever the provider provides an update to one or more files used to compile the data processing model, the data processing model can be automatically and asynchronously recompiled. Thus, use of the data processing model does not have to be discontinued while an update occurs. Rather, the system can just switch over to the newly compiled data processing model once it is ready.

In one embodiment, complication involves several phases including ref analyzing the graph and collecting statistics about each node to enable the compilation module 230 to determine an efficient graph traversal order at calculation time and populate an efficient data storage object (e.g., in a format based on Apache arrow stored in the datastore 250). The compilation module 230 also converts parameter rules and mapping expressions into a compressed efficient format based on Apache arrow to create “Lookups” that can be efficiently queried by an embedded query engine at parameter calculation time.

The compilation module 230 also converts nodes in the Ref Graph that are annotated with sources as coming from the client (e.g. in forms the client fills out when purchasing) into a PriceInput model used to validate payloads sent into the pricing model. For example, at parameter calculation time, each field of the validated price input can be added to the Ref Graph as constants. The compilation module 230 may also collapse any nodes that have no external dependencies in their chains into constants. To achieve this, the compilation module 230 does the arithmetic at compile time and replaces the corresponding node in the graph with a constant.

The compilation module 230 may also analyze the Ref Graph to collect statistics about each node that are used to determine a graph traversal order at parameter calculation time. In one embodiment, the weightings of the nodes and determined based on
source of data (e.g. Constants are fastest, Calculations are fast, Lookups are medium, queries to external data providers like credit reporting agencies are considered very slow)
weight of dependencies of the node in the Ref Graph
the properties of dependent nodes in the Ref Graph (e.g., it doesn't make sense to resolve node c1 which is “fast” before r2 if r2 is “slow” because c1 depends on r2)

The compilation module 230 may create traversal order proposals by applying any suitable algorithm, such as a topological order using Kahn's algorithm, a depth first post order, a level based processing, or an insertion order. For each proposal. the weights of each visit are adjusted based on the fact that each time a node is visited it has a different cost. For example, the first visit is the original weight, the second visit is considered “very fast,” while the third visit is considered “fast,” etc. The compilation module 230 sums up the weights and applies penalties or discounts to the summed weights of each proposal based on the following rules:
a base penalty to account for overhead costs (e.g., due to amortization) at parameter calculation time (insertion order has no penalty so is fastest for small graphs)
For a graph density of 0.19 or less, the topological order may be discounted
A topological penalty may be applied for a maximum dependency chain length that are greater than 100, with a depth first post order discount
For a graph width greater than 2, a level based processing discount is applied
Other similar simple graph statistics can have penalties or discounts can be applied

The compilation module 230 then chooses the traversal order with the smallest adjusted sum of weights. The graph can then be serialized and stored along with graph analysis, algorithm choice, and compiled lookup tables in an efficient format (e.g., an Apache arrow based format). For example, the graph and related data may be uploaded to the datastore 250 of the server 110. Providers may then configure which pricing model is “active” for a given product (e.g., by selecting it using a GUI at a provider device 120).

To give a specific example of ROC compilation, in one embodiment, a ROC can be compiled using the following data processing model and concepts (capitalized terms in the following description correspond to data objects or types within the model):
A Total Price is the result of evaluating a final Step, and an itemized collection of intermediate prices for each Step.
A Step is the model containing a Formula and is responsible for adding its result to the itemized breakdown within the TotalPrice.
   A Formula is the representation of some arithmetic, such as y=m*x+b. The variables and constants within the Formula may be represented by an Attribute.
An Attribute is a reference to an item of data and can be given a user-friendly name to enable ROC attributes to be presented in an intuitive way in a user interface or API (e.g., to give an oversimplified example, TotalPrice=Base Premium*Good Student Discount*Home Owner Bundle Discount). Attributes can have different sources, such as:
   EXTERNAL_INPUT: data that comes into the ROC at premium calculation time from an external source (e.g., a third-party device 140).
   CONSTANT: internal data, configured such that an attribute always resolves to a specific concrete value.
   MAPPING: internal data defined by a LookupFile and associated MappingExpression records. In other words, an attribute that is dependent on other attributes.
   STEP: internal data defined by a Step.
A LookupFile represents actuarial and lookup data. These are files (e.g., .csv files) stored in a database (e.g., datastore 250). LookupFile records have some related metadata that define their schema, as well as MappingExpression records.
   A MappingExpression is how a provider configures the relationship between an input and an output. That is one or more Criterion combined with one or more outputs (MappingToAttribute).
      A Criterion represents a condition for mapping an input column within a LookupFile.
      A MappingToAttribute represents the output if the criteria are met. The output is referencable as an Attribute in a Formula or other MappingExpression records. For example, a MappingExpression may define that if Attribute<Quote Application Region Code>matches to rows within the region_code column of a LookupFile, then Attribute<Base Premium>resolves to the value in the associated row in the base_premium column of a LookupFile.

It should be appreciated that the precompiled data model can (and typically will) contain many more models and configuration options. The above examples are provided to illustrate and explain how compilation of a precompiled data model is performed and why it enables rapid provision of rates. Given the aspects of the data model described above, the name and source of every bit of data used in rate calculation can be known in advance. External inputs can be one of a value that is constrained or completely enumerated by the criteria in all of the MappingExpression records that have output Attribute records that are referenced in any Formula record that are referenced in a Step record; or an unconstrained decimal value that is used directly in a formula. Use of unconstrained decimals can negatively impact optimization, but may be appropriate in some circumstances.

An input can be completely enumerated by using the EQ comparison operator against a set of allowable values. Similarly, an input can be constrained to some range using the LT and/or GT comparison operators. For example, by comparing the age of a driver to minimum and maximum values. As another example, the complete enumeration of supported regions can be determined by looking at the Criterion that depend on the Attribute<Quote Application Region Code>. This provides every possible input for region code. Understanding possible ranges for numbers and dates is a little more complex, but these can also be constrained to unique scenarios by evaluating all of the criteria associated with the relevant input. Since the input is associated with a column in a file, and the output is configured to be resolved by the associated row of another column within the same file, the system knows how inputs and outputs are paired together.

Each lookup file can contain multiple mapping expressions, and a precompiled data processing model version can contain any number of lookup files. Compilation is the process of ingesting each lookup file, row by row, tracking how each mapping expression criterion constrains an input value, and associates it with an output value. These may be represented as ConstraintSet objects. The cartesian product of the constraint sets can be used to produce a Scenario. A Scenario represents a unique set of constraints (ScenarioConstraint) on every allowed input, and a set of Factor records, which are a value and a relationship to an Attribute. The Factor records can be used to resolve most Attributes at premium calculation time.

The query module 240 processes requests for personalized parameters using a precompiled data processing model. In one embodiment, a request for a personalized parameter (e.g., a rate) is received from a provider device 120 or a client device 130. The request includes information about the client. The request may also identify a particular data processing model (e.g., a particular ROC) to use. In embodiments where the server 110 hosts multiple data processing models (e.g., ROCs for different types of product/service, or for different providers of the same product/service), the query module 240 applies the information about the client to the identified precompiled data processing model that outputs the corresponding personalized parameter(s).

In some embodiments, when one or more parameters are requested, the requestor information is serialized and validated, inserted into the Ref Graph, and the graph is sorted by the chosen traversal order. Each node's value is resolved and the results are picked from the results of specific nodes in the graph and returned. In embodiments where the data processing model is a precompiled ROC, the rating system can pre-fetch the “active” pricing models from storage, and uses a dynamic API based on the determined inputs to retrieve the appropriate ROC. In contrast to previous approaches for which calculation time scales exponentially with complexity/variability of the ROC, the described approach may scale approximately linearly with complexity/variability. Because the ROC is precompiled and thus requires (at most) simple linear arithmetic calculations, the rate can be calculated by the ROC substantially instantaneously (e.g., in less than one second).

When client data is received, it can be parsed and matched using configurable protocol options to extract and classify relevant information for calculating a ROC. To give a specific example of rate calculation where the rate is a premium for an insurance policy, in one embodiment, the query module 240 receives client information and parses it into internal types such as decimals, Booleans, dates and times, or strings, etc.) that are defined by the ROC's Attribute records with a matching name and a source of External Input. The query module 240 queries the database (e.g., in datastore 250) for the single Scenario where the constraints match the input and resolves Formulas using the Scenario's related Factor records. Because the ROC was precompiled, once the Scenario has been identified, no further queries are performed, enabling rapid calculation of the premium. Because most of the attributes in the Formula are resolved by the pre-loaded Factor attributes, each attribute is essentially a dictionary lookup. Once calculated, the premium (and, in some cases, an itemization of what is contributing to the premium) is returned to the requesting device.

In some embodiments, further optimization may be realized by collapsing more and more attributes into Factors. In an extreme case, all of the attributes that reference a step may be collapsed in into a factor record and, assuming there are no unconstrained inputs in the ROC, the premium may be obtained with a single lookup operation. Additionally or alternatively, further optimization may be realized by using conditional rounding and other conditional step output modifiers in scenarios and having the factors pre-rounded.

The datastore 250 includes one or more computer readable media that can store the data and models used by other components of the server 110. For example, the datastore 250 can store local copies of files received from providers and the precompiled ROCs generated from those files. Although the datastore 250 is shown as a single component within the server 110, the files and precompiled ROCS (and any other relevant data) may be distributed across multiple storage devices, some or all of which may be accessed remotely via the network 170 (e.g., as part of a distributed database).

### Example Methods

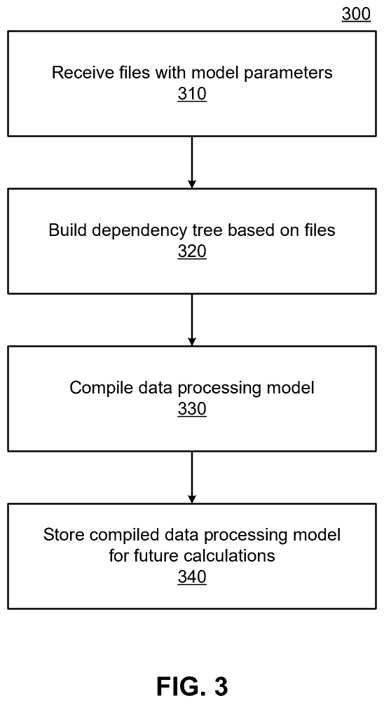

FIG. 3 illustrates a method 300 for precompiling a data processing model, according to one embodiment. The steps of FIG. 3 are illustrated from the perspective of various modules of the server 110 performing the method 300. However, some or all of the steps may be performed by other entities or components. In addition, some embodiments may perform the steps in parallel, perform the steps in different orders, or perform different steps.

In the embodiment shown, the method 300 begins with the data ingestion module 210 receiving 310 files with model parameters. As described previously, the files may be .csv files or other suitable file formats may be used. The data ingestion module 210 parses the files and the dependency tree module 220 builds 320 a dependency tree from the parsed files. The compilation module 230 compiles 330 the data processing model based on the data in the files and the dependency tree. The compiled rate order calculator is stored 340 (e.g., in the datastore 250) for use in making future rate calculations.

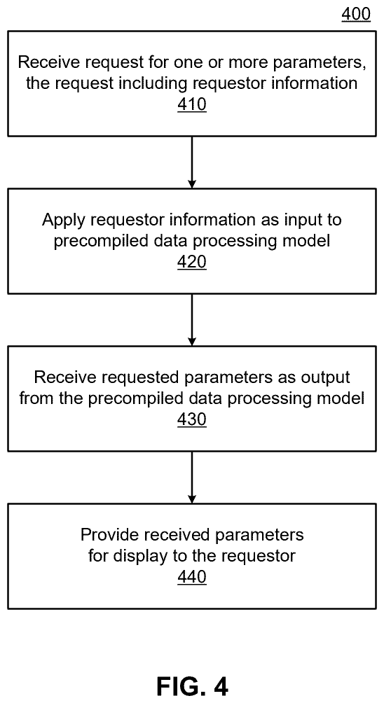

FIG. 4 illustrates a method 400 for using a precompiled data processing model to calculate one or more personalized parameters, according to one embodiment. The steps of FIG. 4 are illustrated from the perspective of the query module 240 performing the method 400. However, some or all of the steps may be performed by other entities or components. In addition, some embodiments may perform the steps in parallel, perform the steps in different orders, or perform different steps.

In the embodiment shown, the method 400 begins with the query module 240 receiving 410 a request for one or more parameters (e.g., a quote for a rate such as an insurance premium). The request includes requestor information about the person or other entity for which the rate is being requested. The request may be received 410 directly from the requestor (e.g., from a client device 130 of the requestor) or from a representative of the provider of the product or service (e.g., from a provider device 120. The query module 240 applies 420 the requestor information as input to a precompiled data processing model (e.g., a ROC) and receives 430 the rate as output from the precompiled data processing model. If needed, additional information may be obtained from external sources (e.g., a third-party device 140) and also provided as input to the precompiled data processing model. The one or more parameters provided by the precompiled data processing model are provided 440 for display to the requestor at a corresponding device (e.g., a provider device 120 or a client device 130).

### Computing System Architecture

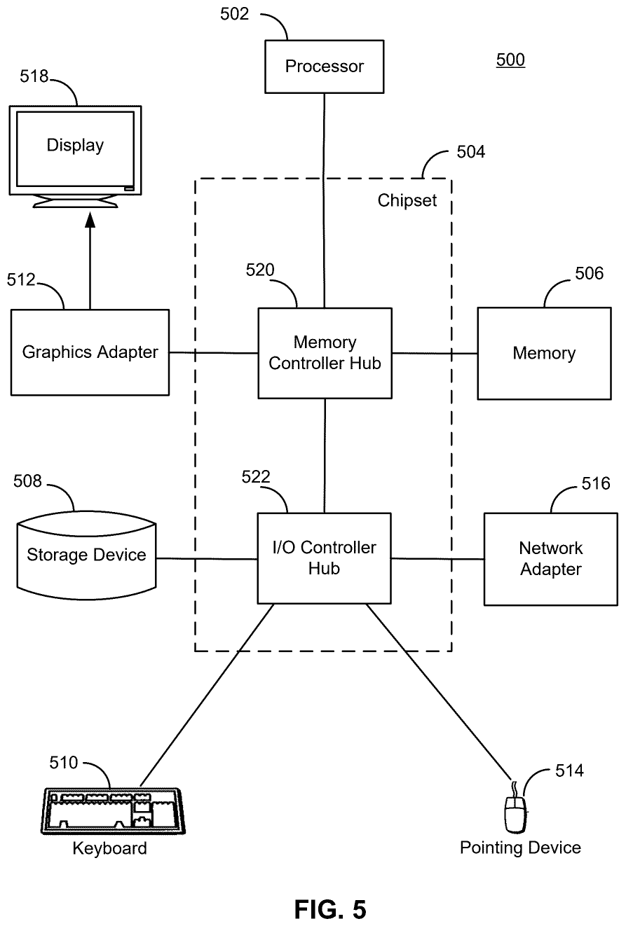

FIG. 5 is a block diagram of an example computer 500 suitable for use as a server 110, provider device 120, client device 130, or third-party device 140. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touchscreen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the server 110 might include multiple blade servers working together to provide the functionality described. Furthermore, the computers can lack some of the components described above, such as keyboards 510, graphics adapters 512, and displays 518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10k% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for calculating personalized parameters using a precompiled data processing model. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a request for a personalized parameter of a product or service, the request including information regarding the requestor;
applying the requestor information as input to a data processing model, wherein the data processing model was precompiled by a process comprising:
receiving model parameters;
building a dependency tree using the model parameters, wherein the dependency tree represents dependencies between model parameters of the data processing model; and
compiling the data processing model using the parameters and the dependency tree;
receiving the personalized parameter as output from the data processing model; and
providing the personalized parameter for display.

2. The computer-implemented method of claim 1, wherein the information about the requestor includes one or more of: a geographic location of the requestor, demographic information of the requestor, a discount the requestor is entitled to, or a parameter for the product or service selected by the requestor.

3. The computer-implemented method of claim 1, wherein the data processing model is a rate order calculator (ROC).

4. The computer-implemented method of claim 1, wherein the model parameters are received in one or more files, the one or more files associating input values in the information regarding the requestor with attributes of the precompiled data processing model.

5. The computer-implemented method of claim 1, further comprising precompiling the data processing model.

6. The computer-implemented method of claim 1, wherein compiling the data processing model using the parameters and the dependency tree comprises calculating values for attributes of the data processing model such that no uncalculated attribute of the data processing model depends on any other uncalculated attribute of the data processing model.

7. The computer-implemented method of claim 1, wherein the personalized parameter is calculated by the data processing model in no more than one second.

8. The computer-implemented method of claim 1, further comprising:
receiving updated parameters for the data processing model;
asynchronously updating the data processing model using the updated parameters;
receiving a second request for a second personalized parameter for the product or service;
calculating the second personalized parameter for the product or service using the updated data processing model; and
providing the second personalized parameter for display to the requestor.

9. The computer-implemented method of claim 1, wherein the data processing model calculates the personalized parameter by a process comprising:
parsing the information regarding the requestor into one or more internal types;
querying a database to identify a single scenario with constraints that match the parsed information regarding the requestor;
resolving one or more formulas for the single scenario without performing additional database queries; and
determining the personalized parameter based on the resolved formulas.

10. The computer-implemented method of claim 1, wherein the product or service is insurance and the personalized parameter is a premium for the insurance.

11. A non-transitory computer-readable medium comprising computer program code that, when executed, causes a computing system to perform operations including:
receiving a request for a personalized parameter of a product or service, the request including information regarding the requestor;
applying the requestor information as input to a data processing model, wherein the data processing model was precompiled by a process comprising:
receiving model parameters;
building a dependency tree using the model parameters, wherein the dependency tree represents dependencies between model parameters of the data processing model; and
compiling the data processing model using the parameters and the dependency tree;
receiving the personalized parameter as output from the data processing model; and
providing the personalized parameter for display.

12. The non-transitory computer-readable medium of claim 11, wherein the information about the requestor includes one or more of: a geographic location of the requestor, demographic information of the requestor, a discount the requestor is entitled to, or a parameter for the product or service selected by the requestor.

13. The non-transitory computer-readable medium of claim 11, wherein the data processing model is a rate order calculator (ROC).

14. The non-transitory computer-readable medium of claim 11, wherein the model parameters are received in one or more files, the one or more files associating input values in the information regarding the requestor with attributes of the precompiled data processing model.

15. The non-transitory computer-readable medium of claim 11, wherein compiling the data processing model using the parameters and the dependency tree comprises calculating values for attributes of the data processing model such that no uncalculated attribute of the data processing model depends on any other uncalculated attribute of the data processing model.

16. The non-transitory computer-readable medium of claim 11, wherein the personalized parameter is calculated by the data processing model in no more than one second.

17. The non-transitory computer-readable medium of claim 11, wherein the operations further include:
receiving updated parameters for the data processing model;
asynchronously updating the data processing model using the updated parameters;
receiving a second request for a second personalized parameter for the product or service;
calculating the second personalized parameter for the product or service using the updated data processing model; and
providing the second personalized parameter for display to the requestor.

18. The non-transitory computer-readable medium of claim 11, wherein the data processing model calculates the personalized parameter by a process comprising:
parsing the information regarding the requestor into one or more internal types;
querying a database to identify a single scenario with constraints that match the parsed information regarding the requestor;
resolving one or more formulas for the single scenario without performing additional database queries; and
determining the personalized parameter based on the resolved formulas.

19. The non-transitory computer-readable medium of claim 11, wherein the product or service is insurance and the personalized parameter is a premium for the insurance.

20. A computer system comprising:
one or more processors; and
one or more non-transitory computer-readable media storing computer program code that, when executed by at least some of the one or more processors, causes the computer system to perform operations including:
receiving a request for a personalized parameter of a product or service, the request including information regarding the requestor;
applying the requestor information as input to a data processing model, wherein the data processing model was precompiled by a process comprising:
receiving model parameters;
building a dependency tree using the model parameters, wherein the dependency tree represents dependencies between model parameters of the data processing model; and
compiling the data processing model using the parameters and the dependency tree;
receiving the personalized parameter as output from the data processing model; and
providing the personalized parameter for display.
